(19) United States
(12) Patent Application Publication
(10) Pub. No.: US 2025/0069405 A1
(43) Pub. Date: Feb. 27, 2025

(54) MONITORING DEVICE AND MONITORING METHOD

(71) Applicant: Sharp NEC Display Solutions, Ltd., Tokyo (JP)

(72) Inventor: Yu SASAKI, Tokyo (JP)

(21) Appl. No.: 18/941,322

(22) Filed: Nov. 8, 2024

Related U.S. Application Data
(63) Continuation of application No. PCT/JP2022/020092, filed on May 12, 2022.

(51) Int. Cl. G06V 20/52; G06T 7/70; G06V 10/74; G06V 40/20

(52) U.S. Cl. CPC G06V 20/52; G06T 7/70; G06V 10/761; G06V 40/20; G06T 2207/20081; G06T 2207/30201; G06T 2207/30232

(57) ABSTRACT

An acquisition unit configured to acquire visual recognition data from which for perceiving positions on a display screen of a display device, wherein the positions are visually recognized by a plurality of viewers and a determination unit configured to acquire a determination result indicating whether or not there is a malfunction in the display device by inputting the visual recognition data acquired by the acquisition unit to a learning-completed model that has learned conditions representing a relationship between the visual recognition data and presence or absence of a malfunction in the display device using the visual recognition data from which positions on a display screen of the display device, which are positions visually recognized by a plurality of viewers, can be perceived and data representing whether or not there is a malfunction in the display device are included.

### TECHNICAL FIELD

The present invention relates to a monitoring device and a monitoring method.

### BACKGROUND ART

In public facilities and stores, there are various solutions for showing advertisements and the like and notifications using video display devices (hereinafter, referred to as displays) such as monitors, projectors, and the like. In such a case, in a case in which a malfunction occurs in a display device, or in a case in which a malfunction occurs in a supply device that supplies input signals to the display device, an intended video may not be able to be correctly displayed.

In a case in which a video is not able to be correctly displayed, there are disadvantages for a display user (hereinafter, referred to as a user) such as an advertiser. For this reason, although it is necessary to detect an occurrence of a malfunction in display details of a display and prompt immediate maintenance such as replacement or device checking in a case in which a malfunction has occurred, costs are incurred to visit a site on which a display is installed and check a display state. For this reason, there is demand from users and administrators to be able to check whether or not an abnormality has occurred in display details using a remote application or the like.

Here, there are technologies for detecting a visual line of a viewer viewing a display (for example, see Patent Document 1).

### CITATION LIST

### Patent Literature

[Patent Literature 1]
Japanese Unexamined Patent Application, First Publication No. 2009-244949

### SUMMARY OF INVENTION

### Technical Problem

However, in a case in which a display state of a display is monitored, there is a method for detecting occurrence/non-occurrence of a malfunction only on the display side by monitoring an internal state of the display using a sensor and the like built into the display. However, in this method, there are types of malfunctions that cannot be detected depending on malfunction details such as “inadequacies on the video device side” and “malfunctions only in a display device of a last-stage panel that cannot be detected by sensors”.

A problem to be solved by the present disclosure is that there are not enough target malfunctions that can be detected in a case in which sensors performing detection inside of a device are used.

### Solution to Problem

According to one aspect of the present invention, there is provided a monitoring device including: an acquisition unit configured to acquire captured data from a camera imaging a place at which a display device can be visually recognized; and a determination unit configured to determine whether or not there is a malfunction in the display device on the basis of viewing actions of a plurality of viewers that are determined from the captured data.

According to one aspect of the present invention, there is provided a monitoring device including: an acquisition unit configured to acquire visual recognition data from which for perceiving positions on a display screen of a display device, wherein the positions are visually recognized by a plurality of viewers; and a determination unit configured to acquire a determination result indicating whether or not there is a malfunction in the display device by inputting the visual recognition data acquired by the acquisition unit to a learning-completed model that has learned conditions representing a relationship between the visual recognition data and presence or absence of a malfunction in the display device using the visual recognition data and data representing whether or not there is a malfunction in the display device.

According to one aspect of the present invention, there is provided a learning device configured to learn conditions representing a relationship between visual recognition data and presence or absence of a malfunction in a display device using the visual recognition data from which positions on a display screen of the display device, which are positions visually recognized by a plurality of viewers, can be perceived and data representing whether or not there is a malfunction in the display device.

According to one aspect of the present invention, there is provided a monitoring method including: acquiring captured data from a camera imaging a place at which a display device can be visually recognized; and determining whether or not there is a malfunction in the display device on the basis of viewing actions of a plurality of viewers that are determined from the captured data.

According to one aspect of the present invention, there is provided a monitoring method including: acquiring visual recognition data from which for perceiving positions on a display screen of a display device, wherein the positions are visually recognized by a plurality of viewers; acquiring a determination result indicating whether or not there is a malfunction in the display device by inputting the visual recognition data to a learning-completed model that has learned conditions representing a relationship between the visual recognition data and presence or absence of a malfunction in the display device using the visual recognition data and data representing whether or not there is a malfunction in the display device; and outputting an alert signal based on the determination result.

### Advantageous Effects of Invention

According to the present invention, captured data acquired from a camera imaging a place at which a display device can be visually recognized is used, and it can be determined whether or not there is a malfunction in the display device from viewing actions of viewers based on the captured data, whereby it can be perceived whether or not there is a malfunction using a technique other than that of a sensor detecting the inside of the device.

### BRIEF DESCRIPTION OF DRAWINGS

FIG. 1 is a system configuration diagram illustrating the configuration of a remote control system S.

FIG. 2 is a schematic functional block diagram illustrating the configuration of a multi-display 30.

FIG. 3 is a schematic functional block diagram illustrating the configuration of a monitoring device 10.

FIG. 4 is a flowchart describing operations of the monitoring device 10.

FIG. 5 is a schematic functional block diagram illustrating the configuration of a monitoring device 10A according to another embodiment.

FIG. 6 is a schematic functional block diagram illustrating the function of a learning device 50.

FIG. 7 is a flowchart describing operations of the monitoring device 10A.

FIG. 8 is a schematic functional block diagram illustrating the configuration of a monitoring device 10B according to another embodiment.

FIG. 9 is a schematic functional block diagram illustrating the configuration of a monitoring device 10C according to another embodiment.

### DESCRIPTION OF EMBODIMENTS

Hereinafter, a remote monitoring system S according to one embodiment of the present invention will be described with reference to the drawings.

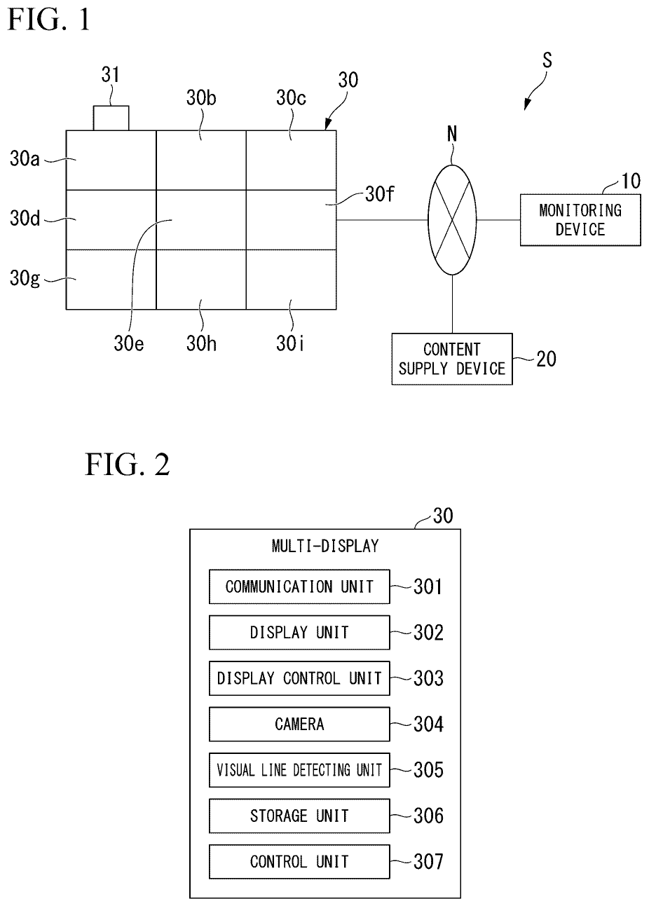

FIG. 1 is a system configuration diagram illustrating the configuration of a remote control system S.

In the remote monitoring system S, a monitoring device 10, a content supply device 20, and a multi-display 30 are connected to be able to communicate with each other through a network N.

The monitoring device 10 controls the multi-display 30 through the network N and acquires information relating to the multi-display 30 through the network N.

A user using the monitoring device 10 can monitor or control the multi-display 30 from a remote place by using the monitoring device 10.

The content supply device 20 stores a content and supplies the content to the multi-display. The content may be an advertisement, a notice, a guide, or the like.

The multi-display 30 has a plurality of displays being adjacently installed and displays a video signal corresponding to a content supplied from the content supply device 20.

In the multi-display 30, a camera 31 is disposed. This camera may be built into the multi-display 30 or may be disposed outside the multi-display 30. In the multi-display 30, here, a total of 9 displays (displays 30a, 30b, 30c, 30d, 30e, 30f, 30g, 30h, and 30i) are adjacently disposed such that three displays are aligned in a vertical direction, and three displays are aligned in a horizontal direction.

The multi-display 30 can display a content as one large display screen including display screens of such a plurality of displays.

The camera 31 images a range in which the multi-display 30 can be visually recognized. More specifically, the camera 31 images a viewer who is present near the display screen of the multi-display 30.

Here, in a case in which a camera is installed in the display, a case in which the camera imaging the display screen of the display is installed in a place different from that of the display is rarely used. On the other hand, the number of cases in which a camera is installed in a display, and the camera images a range in which a display screen of the display can be visually recognized from a position of the display, in other words, a camera that can image a user visually recognizing the display screen of the display is installed increases. For example, an operation of a person (a viewer) standing in front of a display is imaged by a camera, an operation of the imaged person is analyzed, and a content in which an object included in the displayed content is moved in accordance with the operation is provided. In addition, a solution in which a viewer is imaged by a camera disposed in a display, an age group is estimated on the basis of a facial image of the person (the viewer) acquired from the captured image, and an advertisement corresponding to the estimated age group is displayed in the display is provided as well.

In this embodiment, such a camera that is generally used is used, and it is determined whether or not a malfunction has occurred in any one of displays included in a multi-display based on a viewing action for viewing the multi-display on the basis of a captured image acquired from this camera. For this reason, in a case in which a camera is installed in a display, by using this camera, a camera does not need to be additionally installed. In addition, by installing a camera for imaging a display screen of a display at a place different from that of the display and monitoring a captured image acquired from the camera, a system monitoring a display state of the display does not need to be built, and thus there is no need to review places other than the display at which a camera needs to be installed, and installation costs for installing a camera at a place different from that of the display are not incurred.

The network N may be a local area network (LAN) or any other communication network.

FIG. 2 is a schematic functional block diagram illustrating the configuration of the multi-display 30.

The multi-display 30 includes a communication unit 301, a display unit 302, a display control unit 303, a camera 304, a visual line detecting unit 305, a storage unit 306, a control unit 307.

The communication unit 301 communicates with the monitoring device 10 and the content supply device 20 through the network N.

The display unit 302 displays a content based on a video signal. The display unit 302, for example, is a liquid crystal display panel. Here, although 9 displays are included in the multi-display 30, for simplification of description, 9 displays will be collectively described as one display unit 302.

By controlling a drive circuit driving the liquid crystal display panel that is the display unit 302, the display control unit 303 reads a content stored in the storage unit 306 and displays the read content in the display unit 302.

The camera 304 images a range in which the display screen of the multi-display 30 can be visually recognized.

The visual line detecting unit 305 extracts a person (a viewer) included in a captured image on the basis of the captured image captured by the camera 304 and detects a visual line of the person. In addition, the visual line detecting unit 305 detects movement of the visual line of the person and a position at which a person is gazing in the multi-display 30 on the basis of the detected visual line. Furthermore, the visual line detecting unit 305 generates visual line data on the basis a result of detection of the visual line and transmits the generated visual line data to the monitoring device 10 through the communication unit 301. The visual line data represents a viewing action of a viewer viewing a content displayed in the display device by visually recognizing the display screen of the display device. More specifically, the visual line data is data based on a result of detection of a visual line of a person visually recognizing the display screen and is data representing a position that is visually recognized on the display screen of the multi-display from a start timing at which a visual line is detected to a measurement end timing.

The storage unit 306 stores a content supplied from the content supply device 20.

The control unit 307 controls each unit of the multi-display 30.

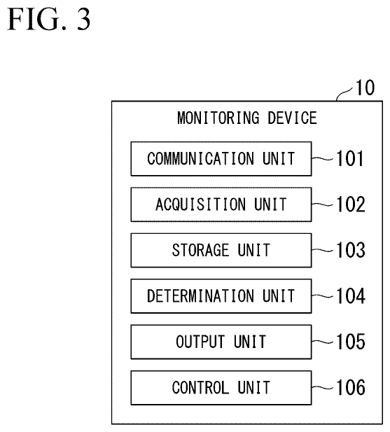

FIG. 3 is a schematic functional block diagram illustrating the configuration of the monitoring device 10.

The monitoring device 10 includes a communication unit 101, an acquisition unit 102, a storage unit 103, a determination unit 104, an output unit 105, and a control unit 106.

The communication unit 101 communicates with the multi-display 30 through the network N.

The acquisition unit 102 acquires visual line data from the multi-display 30.

The storage unit 103 stores visual line data acquired by the acquisition unit 102.

The determination unit 104 determines whether or not a malfunction has occurred in the display device (the multi-display 30) on the basis of viewing actions of a plurality of viewers that are determined from imaged data. For example, the determination unit 104 determines whether or not a malfunction has occurred in the multi-display 30 on the basis of viewing actions represented by visual line data received from the multi-display 30.

Here, when a display screen of one display (for example, a display 30f) among 9 displays of the multi-display 30 is denoted as A, and a malfunction has occurred on this display screen A, in a case of a state in which content is not displayed thereon (for example, there is a no-signal state and the entire screen becomes a black screen (a black screen)), since one content continues to be displayed on display screens other than the display screen A, and thus only the display screen A is black, only the display screen A is viewed as being peculiar by a viewer. For this reason, while one large image is displayed as one content using the screens of 8 displays, only the display screen A becomes a black screen due to a malfunction, and thus the display screen A is individually displayed to be uniquely different and becomes visually more distinctive than the other 8 display screens.

Then, when a viewer viewing the multi-display 30 while moving in front of the display system visually recognizes the multi-display 30 that is in such a display state, the display screen A is visually distinctive, and thus the viewer is predicted to particularly gaze at the display screen A. This can be regarded also as being based on “factors of the same type” of the law of Prägnanz.

In a method for distinguishing a case in which a reader reads a content using the multi-display 30 during a normal operation and a case in which a reader reads a content using the multi-display 30 that is in a state in which a malfunction has occurred in the display screen A from each other on the basis of a viewing action of such a viewer, the determination unit 104 can make determination using features of a visual line operation of each case.

There are mainly the following two determinations that are performed by the determination unit 104.

(1) A determination using visual line features of a reader of the case in which the display is in normal operation.

(2) A determination using visual line features of a viewer of a case in which an abnormal state has occurred in the display.

These two determinations will be described.

(1) Determination Using Visual Line Features of Viewer of Case in which Display is in Normal Operation

In movement of a visual line of a viewer in a case in which the display is operating normally (a case in which a malfunction has not occurred), for example, there are the following features a1 and a2.

(a1) The viewer does not gaze at one point. The visual line of the viewer slightly moves in accordance with a telop or a video displayed as a content. For example, when a character string of a telop is read to advance, the visual line moves. In addition, in a video displayed as a content, a gazing point changes in accordance with interest.

(a2) In a case in which a content is viewed by different viewers, a visual line position of an initial time (a gazing position of the first time) and a visual line position after a predetermined time are different for each viewer, and thus there is no similarity. Particularly, in a case in which the content is a moving image, a first gazing position is different for a displayed content, and, depending on a first gazing start position, the movement of a visual line thereafter is different.

(2) Determination Using Visual Line Features of Viewer of Case in which Abnormal State has Occurred in Display

In movement of a visual line of a viewer of a case in which a malfunction has occurred in at least one display configuring the multi-display, for example, there are the following features b1 and b2.

(b1) One point is gazed at.

(b2) In a case in which a content is viewed by different viewers, there is similarity between the different viewers in a visual line position of the first time (a gazing position of the first time) and a visual line position after a predetermined time. For example, although a position that is gazed at for the first time depends on a viewer, a display of which a display form is peculiar calls attention and thus, the visual line is directed toward the peculiar display. For this reason, there is similarity in a visual line position after a predetermined time between different viewers.

(b3) There is a high likelihood of a display that is gazed at in b1 described above being a display in which a malfunction has occurred.

For example, in the case of a content in which character string information such as a release date is displayed only in a specific display in the multi-display, and large characters and the like are displayed in other displays or the like, the condition a1 described above may occur for a plurality of viewers gazing at the display in which the release date is displayed when there are a plurality of viewers desiring to check the release date. However, in a case in which a content is a moving image, there are a viewer having his or her visual line directed toward a character and then the visual line moving to the display in which the release date is displayed, a viewer having a gazing position of a character to be changed in accordance with movement of this character, and the like, and thus there are differences in characteristics of changes in gazing positions. For this reason, it can be identified whether the display is during a normal operation or a malfunction has occurred therein on the basis of the condition a2.

In consideration of such a condition, the determination unit 104 acquires visual line data including a gazing place (a gazing position) and a gazing time (a time in which the same position is continuously gazed at) from the visual line detecting unit 305 that has detected the visual line data and, in a case in which the number of viewers whose visual line data has been acquired reaches a predetermined number, performs a determination process using the condition described above and a reference value set to the condition. By performing this determination process, it is possible to estimate whether or not a malfunction has occurred in the display. In a case in which it is determined that there is a malfunction, an alert message is output from the output unit 105.

In addition, in a case in which a position, which is a position that a plurality of viewers visually recognize, on the display screen of the display device is focused on a specific area on the display screen regardless of a change in the image displayed in the display device, the determination unit 104 may determine that there is a malfunction in the specific area. A change in an image, for example, is based on whether or not the image of a content displayed on the display screen changes in a reproduction time that is from reproduction of the content until end of reproduction. For example, in a case in which the content is a still image, there is no change in the image while the still image is displayed. In addition, in a case in which the content is a moving image, in a case in which there is no switching between scenes during reproduction of the content, in a case in which a person, scenery, a product, a character string, and the like displayed on the display screen as a content have no movement, have no change in color, scarcely have movement, and the like, it can be determined that there is no change of the image.

In addition, the determination unit 104 may determine whether a specific area is being focused upon on the basis of whether or not there is similarity. For example, it may be determined that a specific area is being focused upon in a case in which there is similarity, and it may be determined that a specific area is not being focused upon in a case in which there is no similarity.

The output unit 105 outputs a determination result. For example, in a case in which it is determined that a malfunction has occurred in the display in the determination result, the output unit 105 outputs an alert. In a case in which an alert is output, the output unit 105 displays a screen representing the alert in a display device built into the monitoring device 10A or a display device disposed outside the monitoring device 10. In addition, the output unit 105 transmits the alert to a terminal device (for example, a smartphone or the like) held by an administrator of the display or a user of the display and causes the terminal device to display an alert screen or generate an alert sound.

The control unit 106 controls each unit of the monitoring device 10.

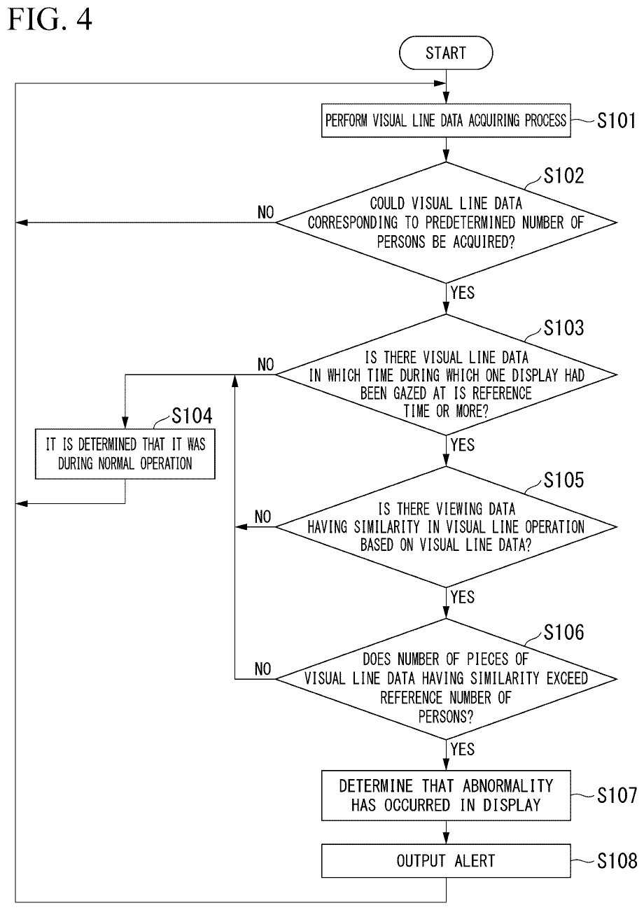

FIG. 4 is a flowchart describing operations of the monitoring device 10.

The multi-display 30 performs imaging using the camera 31. When a person is extracted from a captured image, the visual line detecting unit 305 detects a visual line of the person, generates visual line data representing the position of the visual line during a measurement target time (here, for example, 15 seconds) from a timing at which the visual line has been detected, and transmits the generated visual line data to the monitoring device 10. The visual line detecting unit 305 performs a visual line detecting process for each of persons extracted from a captured image and transmits visual line data to the monitoring device 10 every time the visual line data is generated.

When visual line data is transmitted from the multi-display 30, the acquisition unit 102 of the monitoring device 10 receives (acquires) the visual line data (Step S101). The storage unit 103 stores the acquired visual line data. The determination unit 104 determines whether the number of pieces of received visual line data has reached a determination target person number (Step S102) and, in a case in which the number has not reached the determination target person number (Step S102—No), causes the process to proceed to Step S101. Here, although the determination target person number may be an arbitrary number as long as it is two or more, here, it is preferably the number of persons of a degree from which a tendency of viewing actions of a plurality of viewers can be perceived and, for example, is 10.

In Step S102, in a case in which the number of pieces of received visual line data has reached the determination target person number (Step S102—Yes), the determination unit 104 determines whether there is visual line data in which a time during which one display has been gazed at is a reference time or more (Step S103). The reference time is a time shorter than the measurement target time and is preferably a time of a degree for which it can be perceived that a visual line is continuously directed toward the position of one of the displays and, for example, is one second.

In a case in which there is no visual line data indicating that a visual line has been directed toward the same position for one second or more in the visual line data corresponding to 10 persons (Step S103—No), the determination unit 104 determines that the display is in a normal operation state (Step S104). In such a case, it is estimated that there was no person continuously gazing at a specific position of the display for one second or more among 10 viewers. In addition, in this case, the condition a1 described above is estimated to be satisfied. In this case, the acquisition unit 102 performs a visual line data acquiring process (Step S101).

In Step S103, in a case in which there is visual line data indicating that a visual line has been directed toward the same position for one second or more in the visual line data corresponding to 10 persons (Step S103—Yes), the determination unit 104 causes the process to proceed to Step S105. Then, the determination unit 104 determines whether or not there is visual line data having similarity for visual line operations based on the visual line data (Step S105). For example, the determination unit 104 compares the visual line data corresponding to 10 persons with each other for movement from a gazing position of the first time to a visual line position after a predetermined time and determines the visual line data to have similarity in a case in which the visual line position after at least the predetermined time is the same position or within a predetermined range and determines the visual line data to have no similarity in a case in which the visual line position after the predetermined time is not present at the same position.

In a case in which there is no visual line data having similarity for visual line operations based on the visual line data (Step S105—No), the determination unit 104 determines a state in which the display is normally operating (Step S104). In this case, it can be assumed that only a specific viewer gazed at a specific position of the display and does not gaze thereat due to a malfunction or the like.

On the other hand, in a case in which there is visual line data having similarity for visual line operations based on the visual line data (Step S105—Yes), the determination unit 104 determines whether or not the visual line data having similarity exceeds a reference number of persons (Step S106). The reference number of persons is a number smaller than the predetermined person number in Step S102 and may be the number of persons of a degree for which it can be assumed that the viewing tendency is common and, for example, is six.

In Step S106, in a case in which the visual line data having similarity does not exceed the reference number of persons (Step S106—No), the determination unit 104 determines a state in which the display is normally operating (Step S104). In this case, it can be assumed that, although several viewers gazed at the same position, there were several viewers who watched a place at which a content attracting interest was displayed.

In Step S106, in a case in which visual line data having similarity exceeds the reference number of persons (Step S106—Yes), the determination unit 104 determines that a malfunction has occurred in the display (Step S107).

When it is determined that a malfunction has occurred in the display, the output unit 105 outputs an alert (Step S108).

In this way, viewers are imaged from a camera disposed in the multi-display 30, and it can be determined whether or not a malfunction has occurred in the display on the basis of viewing actions of the viewers for the multi-display 30.

Next, a monitoring device 10A according to another embodiment will be described.

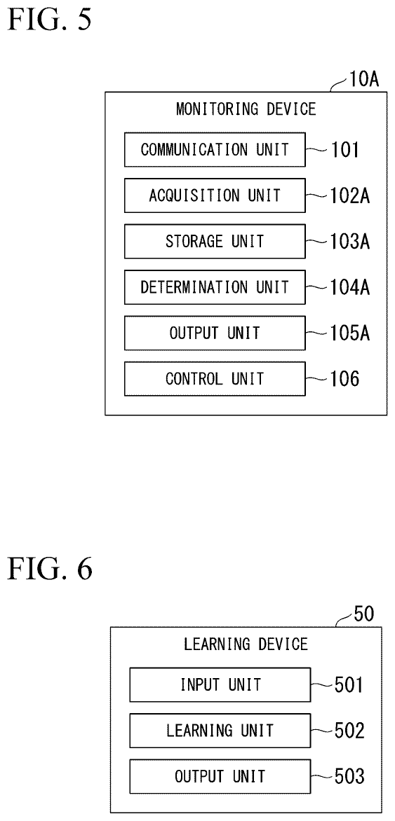

FIG. 5 is a schematic functional block diagram illustrating the configuration of the monitoring device 10A according to the other embodiment. In this diagram, the same reference signs will be assigned to the same functions as those of the monitoring device 10 illustrated in FIG. 3, and description thereof will be omitted. This monitoring device 10A can be disposed in a remote control system S instead of the monitoring device 10 illustrated in FIG. 1.

An acquisition unit 102A acquires capture data from the camera 304 imaging a place at which the multi-display 30 can be visually recognized.

The storage unit 103A stores a learning-completed model.

The learning-completed model is a model that is generated by causing a learning model to execute supervised learning. The learning-completed model is a model that has learned a condition representing a relationship between visual recognition data and an occurrence/non-occurrence of a malfunction in a display by using the visual recognition data from which positions, which are positions on the display screen of the display device, visually recognized by a plurality of viewers can be perceived and label data representing whether or not there is a malfunction in the display.

The visual recognition data, for example, may be captured data or stop data that represents a visually-recognized position and a continuation time.

The captured data is data acquired by imaging a place at which the display can be visually recognized and, for example, captured data acquired from the camera 31 is used as the captured data. In this captured data, viewers visually recognizing displays are included, and thus a position on the display screen of a display that is visually recognized by a viewer can be perceived.

The captured data may be captured data acquired from a camera mounted in a multi-display having the same format as the multi-display that is a monitoring target or having the numbers of displays aligned in a vertical direction and a horizontal direction to be the same.

The stop data is data including a visually-recognized position, which is a position visually recognized by a viewer, representing a position on the display screen of a display device and a continuation time that is a time during which a visual line had been continuously directed to this visually-recognized position.

As a method for acquiring stop data, for example, there is a method of measuring a time during which a visually-recognized position visually recognized by a viewer is continued for each visually-recognized position on the basis of captured data. In addition, as another method of acquiring stop data, there is a method of acquiring a visually-recognized position and a continuation time by inputting captured data acquired from the camera 31 to a learning-completed model from which a visually-recognized position and a continuation time can be acquired by inputting captured data thereto.

The learning-completed model performs learning for being able to predict whether or not a malfunction has occurred in a multi-display that is a monitoring target on the basis of input visual recognition data.

As the learning-completed model, there is a first learning-completed model that has learned conditions representing a relationship between captured data and presence or absence of a malfunction in the display device using captured data acquired by imaging a place at which displays can be visually recognized and data representing whether or not there is a malfunction in the display device.

In addition, as the learning-completed model, there is a second learning-completed model that has learned conditions representing a relationship between stop data that is a combination of a visually-recognized position, which is a position visually recognized by a viewer, representing a position on the display screen of the display device and a continuation time that is a time during which the visual line had been continuously directed to this visually-recognized position and whether there is a malfunction in the display device.

In addition, the learning-completed model may predict whether or not a malfunction has occurred or may predict a degree of occurrence of a malfunction using a probability or the like.

A model (learning model) to be learned by the learning-completed model may be a model to which an arbitrary machine learning technique is applied. For example, the learning model may be a deep learning model using a deep neural network (DNN), a convolutional neural network (CNN), or the like known as an image classification model for recognizing and classifying images.

The determination unit 104A inputs captured data to a learning-completed model stored in the storage unit 103A, thereby acquiring a determination result indicating whether or not there is a malfunction in the multi-display 30. In other words, by inputting visual recognition data to a learning-completed model that has learned conditions representing a relationship between visual recognition data and an occurrence/non-occurrence of a malfunction in the display device using the visual recognition data from which positions on the display screen of the display device described above, which are positions visually recognized by a plurality of viewers, can be perceived and data representing whether or not there is a malfunction in the display device, the determination unit 104A acquires a determination result indicating whether or not there is a malfunction in the display device.

The determination unit 104A may determine whether or not there is a malfunction in the display device using any one of the first learning-completed model and the second learning-completed model.

In a case in which the first learning-completed model is used, the determination unit 104A acquires a result indicating whether or not there is a malfunction in the display device by inputting captured data acquired from the outside to the first learning-completed model, thereby determining whether or not there is a malfunction in the display device.

In addition, in a case in which the second learning-completed model is used, the determination unit 104A acquires a result indicating whether or not there is a malfunction in the display device by inputting stop data acquired on the basis of captured data to the second learning-completed model, thereby determining whether or not there is a malfunction in the display device.

In a case in which the second learning-completed model is used, the determination unit 104A may acquire stop data from a measurement device, which is a measurement device disposed outside the monitoring device 10A, acquiring the stop data from captured data. In addition, by providing a measurement function of such a measurement device in the monitoring device 10A, stop data may be acquired from the measurement function.

In addition, in a case in which the second learning-completed model is used, the determination unit 104A may acquire stop data by inputting captured data to a third learning-completed model from which visually-recognized position and a continuation time can be acquired by inputting captured data thereto. The third learning-completed model is a learning-completed model that has learned a relation between captured data and a visually-recognized position and a continuation time. By providing a function for acquiring stop data using the third learning-completed model in an external device, the determination unit 104A may acquire the stop data, or by providing the function described above inside the monitoring device 10A, the determination unit 104A may acquire stop data from the third learning-completed model. In this case, the monitoring device 10A acquires stop data from the captured data using the third learning-completed model and determines whether or not there is a malfunction in the display device by inputting the stop data to the second learning-completed model. For this reason, in the monitoring device 10A, by using learning-completed models in two stages, it is determined whether or not there is a malfunction in the display device.

The output unit 105A outputs an alert signal on the basis of a determination result acquired by the determination unit 104A.

FIG. 6 is a schematic functional block diagram illustrating the function of a learning device 50.

The learning device 50 includes an input unit 501, a learning unit 502, and an output unit 503.

The input unit 501 acquires teacher data in which captured data acquired by imaging a place at which the display device can be visually recognized and label data representing whether or not there is a malfunction in the display device are associated with each other. For example, this teacher data includes first teacher data in which a viewing action (movement of a visual line and the like) of a viewer of a case in which a malfunction has occurred in the multi-display and label data representing an occurrence of the malfunction are associated with each other and second teacher data in which a viewing action of a viewer of a case in which no malfunction has occurred in the multi-display and label data representing no occurrence of a malfunction are associated with each other. It is preferable that each of the first teacher data and the second teacher data be a large amount of data acquired in a different scene at a different time.

For example, by imaging a place at which the display device can be visually recognized using a camera in a state in which no malfunction has occurred in the display device, the input unit 501 of the learning device 50 collects captured data acquired by imaging viewing actions of viewers in the state in which no malfunction has occurred. Then, the learning unit 502 assigns label data representing that no malfunction has occurred to this captured data. Here, by acquiring captured data that is different for each viewer, a plurality of pieces of captured data are collected, and label data is assigned to each thereof, whereby teacher data is generated.

Then, in a case in which a malfunction has occurred, the input unit 501 extracts captured data, which is acquired by imaging viewing actions of viewers, captured by the camera in a period in which the malfunction has occurred. The learning unit 502 assigns label data representing that a malfunction has occurred to this captured data, thereby generating teacher data.

Then, the learning unit 502 learns using the generated teacher data.

The learning unit 502 generates a learning-completed model by learning conditions representing a relationship between visual recognition data and presence or absence of a malfunction in the display using visual recognition data from which positions on the display screen of the display device, which are positions visually recognized by a plurality of viewers, can be perceived and data representing presence or absence of a malfunction in the display. A learning-completed model generated by the learning unit 502 may be any one or a plurality of the first learning-completed model, the second learning-completed model, and the third learning-completed model described above.

The output unit 503 outputs the learning-completed model generated by the learning unit 502 to an external device. For example, the output unit 503 outputs the learning-completed model to the monitoring device 10A. In this case, the output unit 503 of the learning device 50 and the monitoring device 10A are connected to be able to communicate with each other through a communication cable, a communication network, or the like, and by transmitting data that is the learning-completed model from the output unit 503 of the learning device 50 to the monitoring device 10A, the learning-completed data is output.

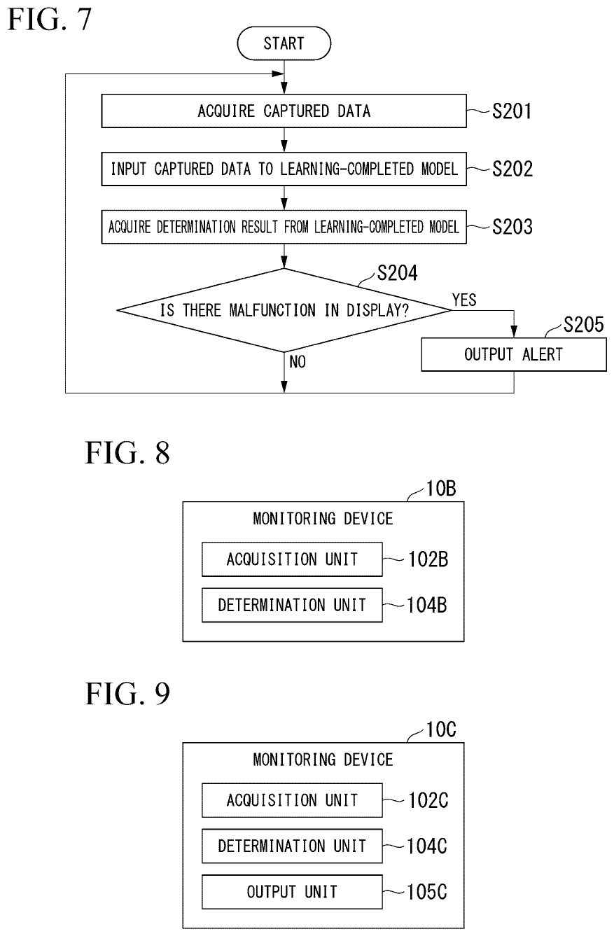

FIG. 7 is a flowchart describing operations of the monitoring device 10A.

The acquisition unit 102A of the monitoring device 10A acquires captured data from the camera 31 of the multi-display 30 (Step S201).

The determination unit 104A inputs the acquired captured data to the learning-completed model (Step S202) and acquires a determination result from the learning-completed model (Step S203). Then, the determination unit 104A determines whether or not the determination result indicates an occurrence of a malfunction in the display (Step S204).

The determination unit 104A causes the process to proceed to Step S201 in a case in which the determination result acquired from the learning-completed model does not represent an occurrence of a malfunction in the display (Step S204—No) and causes the output unit 105A to output an alert (Step S205) in a case in which the determination result acquired from the learning-completed model represents an occurrence of a malfunction in the display (Step S204—Yes).

In the embodiment described above, although a case in which the monitoring target is the multi-display 30 has been described, the monitoring target is not limited to the multi-display and may be a display group in which a plurality of display devices are aligned in adjacent or close positions or may be a digital signage as long as it includes a camera. In the display group of this case, each display may display one content. In addition, the monitoring target can be applied also to a multi-display system, in which screens projected by a plurality of projectors are adjacent to each other, displaying one content using the plurality of projection screens.

FIG. 8 is a schematic functional block diagram illustrating the configuration of a monitoring device 10B according to another embodiment.

The monitoring device 10B includes an acquisition unit 102B and a determination unit 104B.

The acquisition unit 102B acquires visual recognition data from which positions on the display screen of the display device, which are positions visually-recognized by a plurality of viewers, can be perceived. As a camera of this case, a camera mounted in the display device can be used. The determination unit 104B acquires a determination result indicating whether or not there is a malfunction in the display device described above by inputting the visual recognition data acquired by the acquisition unit described above to a learning-completed model that has learned conditions representing a relationship between the visual recognition data described above and presence or absence of a malfunction in the display device described above using the visual recognition data from which positions on the display screen of the display device described above, which are positions visually recognized by a plurality of viewers, can be perceived and data representing whether or not there is a malfunction in the display device. The visual recognition data, for example, includes data from which positions on the display screen of the display device to which viewers have their visual lines directed or positions that viewers are viewing can be perceived. For example, in a case in which there is a tendency of a plurality of viewers being viewing the same position on the display screen, it can be determined that a malfunction has occurred at the position on the display screen.

FIG. 9 is a schematic functional block diagram illustrating the configuration of a monitoring device 10C according to another embodiment.

The monitoring device 10C includes an acquisition unit 102C, a determination unit 104C, and an output unit 105C.

The acquisition unit 102C acquires visual recognition data from which positions on the display screen of the display device, which are positions visually recognized by a plurality of viewers, can be perceived.

The determination unit 104C acquires a determination result indicating whether or not there is a malfunction in the display device by inputting visual recognition data to a learning-completed model that has learned conditions representing a relationship between the visual recognition data and presence or absence of a malfunction in the display device using the visual recognition data from which positions on the display screen of the display device, which are positions visually recognized by a plurality of viewers, can be perceived and data representing whether or not there is a malfunction in the display device.

The output unit 105C outputs an alert signal based on a determination result.

In the embodiment described above, each of the storage units 103, 103A, and 306 is configured using a storage medium, for example, a hard disk drive (HDD), a flash memory, an electrically erasable programmable read only memory (EEPROM), a random access memory (RAM), a read only memory (ROM), or an arbitrary combination of such storage media.

As such storage units, for example, a non-volatile memory can be used.

In addition, in the embodiment described above, the acquisition units 102 and 102A, the determination units 104 and 104A, the control unit 106, the display control unit 303, the visual line detecting unit 305, the control unit 307, the input unit 501, and the learning unit 502, for example, may be configured using processing devices such as central processing units (CPU) or dedicated electronic circuits.

In addition, by recording a program for realizing functions of the processing units illustrated in FIG. 1 on a computer-readable recording medium and causing a computer system to read and execute the program recorded on this recording medium, execution management may be performed. The “computer system” described here includes an operating system (OS) and hardware such as peripherals.

In addition, “computer system” is assumed to include home page provision environments (or display environments) in a case in which it uses a WWW system.

Furthermore, the “computer-readable recording medium” represents a portable medium such as a flexible disk, a magneto-optical disk, a ROM, or a CD-ROM or a storage device such as a hard disk built into the computer system. Furthermore, the “computer-readable recording medium” may include a medium storing a program for a predetermined time such as an internal volatile memory of the computer system that serves as a server or a client. In addition, the program described above may be a program used for realizing a part of the function described above or a program that can realize the function described above in combination with a program that is already recorded in the computer system. In addition, the program described above may be stored in a predetermined server, and this program may be configured to be distributed (downloaded or the like) through a communication line in accordance with a request from another device.

As above, although the embodiments of the present invention have been described in detail with reference to the drawings, a specific configuration is not limited to these embodiments, and various designs and the like in a range not departing from the concept of the present invention are included therein.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### REFERENCE SIGNS LIST

10, 10A, 10B, 10C Monitoring device
20 Content supply device
30 Multi-display
30a, 30b, 30c, 30d, 30e, 30f, 30g, 30h, 30i Display
31 Camera
50 Learning device
101 Communication unit
102, 102A, 102B, 102C Acquisition unit
103, 103A, 306 Storage unit
104, 104A, 104B, 104C Determination unit
105, 105A, 105C, 503 Output unit
106, 307 Control unit
301 Communication unit
302 Display unit
303 Display control unit
304 Camera
305 Visual line detecting unit
501 Input unit
502 Learning unit

What is claimed is:

1. A monitoring device comprising:
an acquisition unit configured to acquire captured data from a camera imaging a place at which a display device can be visually recognized; and
a determination unit configured to determine whether or not there is a malfunction in the display device on the basis of viewing actions of a plurality of viewers that are determined from the captured data.

2. The monitoring device according to claim 1, wherein the determination unit determines whether or not there is a malfunction in the display device on the basis of positions on a display screen of the display device, which are positions visually recognized by the plurality of viewers, determined as the viewing actions of the plurality of viewers.

3. The monitoring device according to claim 2, wherein the determination unit determines that there is a malfunction in a specific area in a case in which the positions on the display screen of the display device, which are positions visually recognized by the plurality of viewers, are concentrated in the specific area on the display screen regardless of a change in an image displayed in the display device.

4. The monitoring device according to claim 2, wherein the determination unit determines whether or not there is similarity on the basis of a history of the positions on the display screen visually recognized by the viewers and determines whether or not there is a malfunction in the display device on the basis of a determination result.

5. The monitoring device according to claim 4, wherein the determination unit determines whether or not there is similarity of second positions that are visually recognized by the viewers after visual recognition of first positions.

6. The monitoring device according to claim 5, wherein the determination unit determines whether or not there is a malfunction in the display device on the basis of whether or not the number of viewers with respect to this similarity has reached a reference number of persons.

7. The monitoring device according to claim 1, wherein the acquisition unit acquires an image in which viewers visually recognizing a content displayed on the display screen of the display device are imaged from a camera mounted in the display device.

8. A monitoring device comprising:
an acquisition unit configured to acquire visual-recognition data from which for perceiving positions on a display screen of a display device, wherein the positions are visually recognized by a plurality of viewers; and
a determination unit configured to acquire a determination result indicating whether or not there is a malfunction in the display device by inputting the visual-recognition data acquired by the acquisition unit to a learning-completed model that has learned conditions representing a relationship between the visual recognition data and presence or absence of a malfunction in the display device using the visual recognition data and data representing whether or not there is a malfunction in the display device.

9. A monitoring method comprising:
acquiring visual recognition data for perceiving positions on a display screen of a display device, wherein the positions are visually recognized by a plurality of viewers;
acquiring a determination result indicating whether or not there is a malfunction in the display device by inputting the visual recognition data to a learning-completed model that has learned conditions representing a relationship between the visual recognition data and presence or absence of a malfunction in the display device using the visual recognition data and data representing whether or not there is a malfunction in the display device; and
outputting an alert signal based on the determination result.
